(19) United States
(12) Patent Application Publication
(10) Pub. No.: US 2020/0235912 A1
(43) Pub. Date: Jul. 23, 2020

(54) IMMUTABLE ASSET AND CONNECTED SERVICE MANAGEMENT

(71) Applicant: ServiceNow, Inc., Santa Clara, CA (US)

(72) Inventor: Tasker O. Generes, JR., Northfield (CA)

(21) Appl. No.: 16/368,676

(22) Filed: Mar. 28, 2019

Related U.S. Application Data
(60) Provisional application No. 62/795,939, filed on Jan. 23, 2019.

(51) Int. Cl. H04L 9/06; G06Q 10/06; H04L 9/14

(52) U.S. Cl. CPC H04L 9/0637; G06Q 10/06393; H04L 2209/38; H04L 9/14; G06Q 2220/10; G06Q 10/0633

(57) ABSTRACT

Managing an immutable asset includes utilizing, by a first service provider, a first key associated with a first asset to access a first workflow associated with the first asset, wherein the workflow is enabled in response to verifying the first asset using the first key, performing the first workflow to obtain modified asset attributes for the first asset, and storing an indication of the modified asset attributes in a blockchain associated with the first asset, wherein the second service provider has a second key associated with the modified first asset and access to the blockchain

### CROSS REFERENCE TO RELATED APPLICATIONS

This application is a continuation of U.S. Provisional Application No. 62/795,939, filed Jan. 23, 2019, the contents of which are herein expressly incorporated by reference for all purposes.

### TECHNICAL FIELD

Embodiments described herein generally relate to connected services, and more particularly, to creating and managing an immutable asset and connected services.

### BACKGROUND

A variety of enterprise and/or information technology (IT) related software applications may be utilized to support various functions of an enterprise such as Finance, Human Resource (HR), IT, Legal, Marketing, Sales, and the like. The software applications may be deployed on an instance platform on a server and accessed as needed over a network such as a Local Area Network (LAN) or the Internet. The server may be a local enterprise server as part of a self-hosted system or a remote server located in the Cloud as part of a cloud computing system.

Cloud computing relates to sharing of computing resources that are generally accessed via the Internet. In particular, cloud computing infrastructure allows users to access a shared pool of computing resources, such as servers, storage devices, networks, applications, and/or other computing-based services. By doing so, users, such as individuals and/or enterprises, are able to access computing resources on demand that are located at remote locations in order to perform a incidevariety of computing functions that include storing and/or processing computing data. For enterprise and other organization users, cloud computing provides flexibility in accessing cloud computing resources without accruing up-front costs, such as purchasing network equipment and investing time in establishing a private network infrastructure. Instead, by utilizing cloud computing resources, users are able redirect their resources to focus on core enterprise functions.

### SUMMARY

The following presents a simplified summary of the disclosed subject matter in order to provide a basic understanding of some aspects of the subject matter disclosed herein. This summary is not an exhaustive overview of the technology disclosed herein. It is not intended to identify key or critical elements of the invention or to delineate the scope of the invention. Its sole purpose is to present some concepts in a simplified form as a prelude to the more detailed description that is discussed later.

In one embodiment a method includes: utilizing, by a first service provider, a first key associated with a first asset to access a first workflow associated with the first asset, wherein the workflow is enabled in response to verifying the first asset using the first key, performing the first workflow to obtain modified asset attributes for the first asset, and storing an indication of the modified asset attributes in a blockchain associated with the first asset, wherein the second service provider has a second key associated with the modified first asset and access to the blockchain.

In another embodiment, the method may be embodied in computer executable program code and stored in a non-transitory storage device. In yet another embodiment, the method may be implemented on a (cloud-based or self-hosted) computer system.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 illustrates a block diagram of self-hosted network system 100 where one or more embodiments of the present disclosure may operate.

FIG. 2 illustrates a block diagram of cloud computing infrastructure 200 where one or more embodiments of the present disclosure may operate.

FIG. 3 illustrates a block diagram of a network architecture 300 where one or more embodiments of the present disclosure may operate.

FIG. 4 illustrates a flowchart for creating and managing an immutable asset, according to one or more embodiments.

FIG. 5 shows a flowchart for managing a connected service, according to one or more embodiments.

FIG. 6 shows an example flow diagram illustrating connected services, according to one or more embodiments.

FIG. 7 illustrates a high-level block diagram 700 of a processing device (computing system) that may be used to implement one or more disclosed embodiments.

### DESCRIPTION OF EMBODIMENTS

In the following description, for purposes of explanation, numerous specific details are set forth in order to provide a thorough understanding of the embodiments disclosed herein. It will be apparent, however, to one skilled in the art that the disclosed embodiments may be practiced without these specific details. In other embodiments, structure and devices are shown in block diagram form in order to avoid obscuring the disclosed embodiments. Moreover, the language used in this disclosure has been principally selected for readability and instructional purposes, and may not have been selected to delineate or circumscribe the inventive subject matter, resorting to the claims being necessary to determine such inventive subject matter. Reference in the specification to “one embodiment” or to “an embodiment” means that a particular feature, structure, or characteristic described in connection with the embodiments is included in at least one embodiment.

The terms “a,” “an,” and “the” are not intended to refer to a singular entity unless explicitly so defined, but include the general class of which a specific example may be used for illustration. The use of the terms “a” or “an” may therefore mean any number that is at least one, including “one,” “one or more,” “at least one,” and “one or more than one.” The term “or” means any of the alternatives and any combination of the alternatives, including all of the alternatives, unless the alternatives are explicitly indicated as mutually exclusive. The phrase “at least one of” when combined with a list of items, means a single item from the list or any combination of items in the list. The phrase does not require all of the listed items unless explicitly so defined.

The term “computing system” is generally taken to refer to at least one electronic computing device that includes, but is not limited to a single computer, virtual machine hosted on one of more physical devices, virtual container hosted on one or more physical devices, host, server, laptop, tablet, and/or mobile device or to a plurality of electronic computing devices working together to perform the function described as being performed on or by the computing system.

As used herein, the term “medium” or “memory” refers to one or more non-transitory physical media that together store the contents described as being stored thereon. Embodiments may include non-volatile secondary storage, read-only memory (ROM), and/or random-access memory (RAM).

As used herein, the term “application” refers to one or more computing modules, programs, processes, workloads, threads and/or a set of computing instructions executed by a computing system or one or more hardware processors. Example embodiments of an application include software modules, software objects, software instances and/or other types of executable code.

As used herein, the term “workflow” refers to a sequence of activities that comprise a process across a platform. Embodiments may include workflows related to Finance, Human Resource (HR), IT, Legal, Marketing, Sales, Production, and the like.

As used herein, the term “asset” refers to any physical or digital entity which holds value to an enterprise. Assets may include, for example, IT assets (e.g., network devices, IoT devices, and other technological devices), inventory, digital workflows, and the like. Assets may also include other kinds of assets, such as HR assets (e.g., employees, teams, and the like). Further, assets may include individual components, or systems of components.

This disclosure relates to methods and systems for generating and managing immutable assets. In addition, this disclosure describes managing new and identified assets in a platform via blockchain ledger. In one or more embodiments, a workflow associated with an asset is unlocked based on a key associated with the asset. For example, the asset may be verified using the key. The workflow may then be performed by the service provider, resulting modified asset attributes for the asset. The modified asset attributes may be stored in a blockchain associated with the asset. The workflow, and key may be stored in association with the asset in a general ledger associated with the blockchain. In some embodiments, performance of the workflow may be monitored, for example, to determine a key performance indicator (“KPI”). According to one or more embodiments, KPIs may be monitored in order to initiate or kick off a subsequent workflow. Further, in one or more embodiments, if a new asset is discovered based on the workflow, the asset is also added to the general ledger.

Although the following describes a blockchain that is utilized to store asset attributes and to determine access to workflows, the structure in which the asset attributes are stored may be a different component, such as a decentralized ledger accessible to operators for an asset.

According to one or more embodiments, the method protects an immutable asset by preventing initiation of a workflow in the case where the asset is unexpected. For example, if a service provider attempts to access a workflow associated with an asset, and the asset is unexpected, then the key used by the service provider will not provide access. Further, a failed access notification may be generated and transmitted to a user or authority, such as an enterprise management system, or manager internal to the service provider, to alert that an asset has been found to be invalid.

In one or more embodiments, the record data associated with the assets, workflows, and services, may be unique to a customer enterprise, and multiple customer enterprises may be served by embodiments described herein.

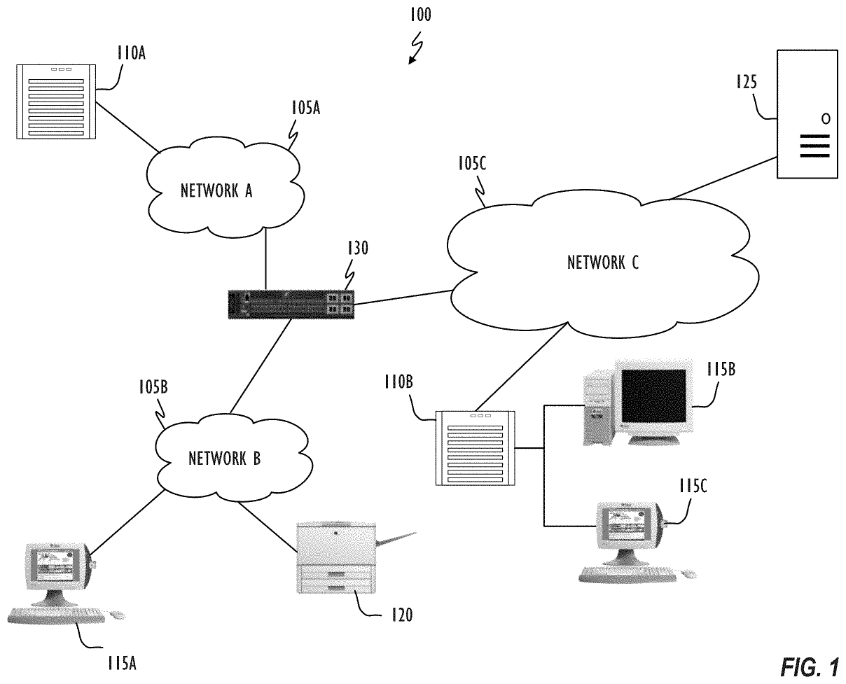

FIG. 1 depicts an illustrative self-hosted network system 100 where one or more embodiments of the present disclosure may operate. This illustrative network system 100 may include a plurality of networks 105, (i.e., 105A, 105B, and 105C), each of which may take any form including, but not limited to, a local area network (LAN) or a WAN, such as the Internet. Further, networks 105 may use any desired technology (wired, wireless, or a combination thereof) and protocol (e.g., transmission control protocol, TCP). Coupled to networks 105 are data server computers 110 (i.e., 110A and 110B) that are capable of operating server applications such as databases and also capable of communicating over networks 105. One embodiment using server computers may involve the operation of one or more central systems to log user session data and identify session signatures of the user session.

Client computers 115 (i.e., 115A, 115B, and 115C), which may take the form of any smartphone, gaming system, tablet, computer, set top box, entertainment device/system, television, telephone, communications device, or intelligent machine, including embedded systems, may also be coupled to networks 105, and/or data server computers 110. In some embodiments, network system 100 may also include network printers such as printer 120 and storage systems such as 125, which may be used to store user session data or other data that are referenced herein. To facilitate communication between different network devices (e.g., data servers 110, end-user computers 115, network printer 120, and storage system 125), at least one gateway or router 130 may be optionally coupled there between. Furthermore, to facilitate such communication, each device employing the network may comprise a network adapter circuit and related software. For example, if an Ethernet network is desired for communication, each participating device must have an Ethernet adapter or embedded Ethernet capable ICs. Further, the devices may carry network adapters for any network in which they might participate (including, but not limited to, personal area networks (PANs), LANs, WANs, and cellular networks).

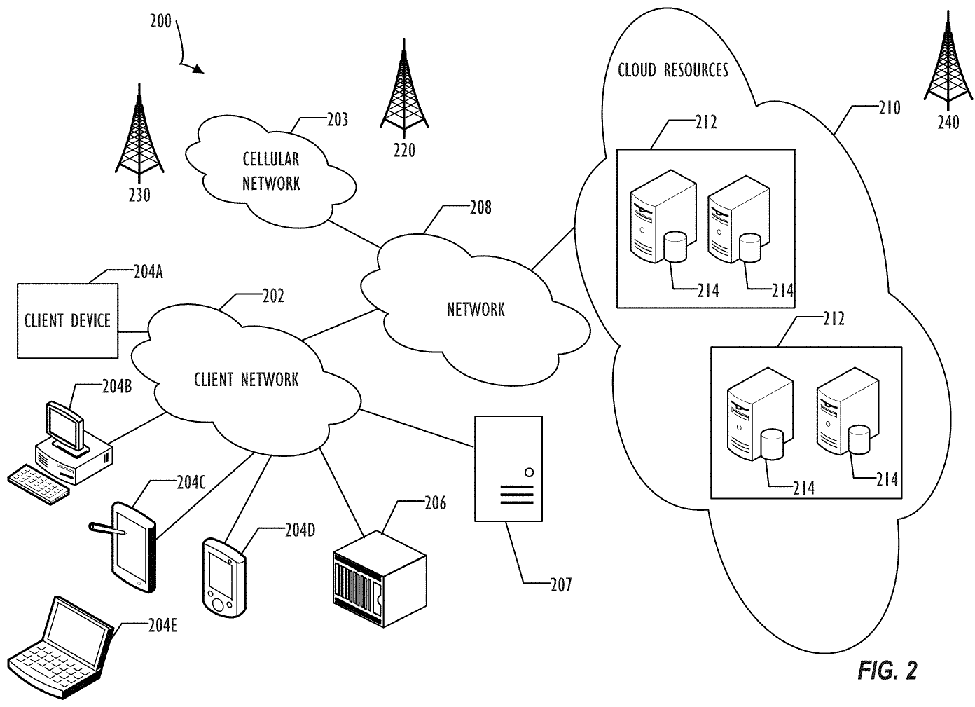

FIG. 2 illustrates a block diagram of an embodiment of a cloud computing infrastructure 200 where one or more embodiments of the present disclosure may operate. Cloud computing infrastructure 200 comprises a client network 202, network 208, and a cloud resources platform/network 210. In one embodiment, the client network 202 may be a local private network such as LAN that includes a variety of network devices that include, but are not limited to switches, servers, and routers. Each of these networks can contain wired or wireless programmable devices and operate using any number of network protocols (e.g., TCP/IP) and connection technologies (e.g., Wi-Fi® networks, Bluetooth®). Wi-Fi is a registered trademark of the Wi-Fi Alliance. Bluetooth is a registered trademark of Bluetooth Special Interest Group. In another embodiment, client network 202 represents an enterprise network that could include or be communicatively coupled to one or more local area networks (LANs), virtual networks, data centers and/or other remote networks (e.g., 208, 210). As shown in FIG. 2, client network 202 may be connected to one or more client devices 204A-E and allow the client devices to communicate with each other and/or with cloud resources platform/network 210. Client devices 204A-E may be computing systems such as desktop computer 204B, tablet computer 204C, mobile phone 204D, laptop computer (shown as wireless) 204E, and/or other types of computing systems generically shown as client device 204A. Each of client devices 204A-E may be similar to any of client computers 115 of network system 100 shown in FIG. 1. FIG. 2 also illustrates that client network 202 may be connected to a local compute resource 206 that may include a server, access point, router, or other device configured to provide for local computational resources and/or to facilitate communication amongst networks and devices. For example, local compute resource 206 may be one or more physical local hardware devices configured to communicate with wireless network devices and/or facilitate communication of data between client network 202 and other networks such as network 208 and cloud resources platform/network 210. Local compute resource 206 may also facilitate communication between other external applications, data sources, and services, and client network 202.

FIG. 2 also illustrates that client network 202 may be connected to a computer configured to execute a management, instrumentation, and discovery (MID) server 207. For example, MID server 207 may be a Java® application that runs as a Windows® service or UNIX® daemon. Java is a registered trademark of Oracle America, Inc. Windows is a registered trademark of Microsoft Corporation. UNIX is a registered trademark of The Open Group. MID server 207 may be configured to assist functions such as, but not necessarily limited to, discovery, orchestration, service mapping, service analytics, and event management. MID server 207 may be configured to perform tasks for a cloud-based instance while never initiating communication directly to the cloud-instance by utilizing a work queue architecture. This configuration may assist in addressing security concerns by eliminating that path of direct communication initiation.

Cloud computing infrastructure 200 also includes cellular network 203 for use with mobile communication devices. Mobile cellular networks support mobile phones and many other types of mobile devices such as laptops etc. Mobile devices in cloud computing infrastructure 200 are illustrated as mobile phone 204D, laptop 204E, and tablet 204C. A mobile device such as mobile phone 204D may interact with one or more mobile provider networks as the mobile device moves, typically interacting with a plurality of mobile network towers 220, 230, and 240 for connecting to the cellular network 203. Although referred to as a cellular network in FIG. 2, a mobile device may interact with towers of more than one provider network, as well as with multiple non-cellular devices such as wireless access points and routers (e.g., local compute resource 206). In addition, the mobile devices may interact with other mobile devices or with non-mobile devices such as desktop computer 204B and various types of client device 204A for desired services. Although not specifically illustrated in FIG. 2, client network 202 may also include a dedicated network device (e.g., gateway or router) or a combination of network devices that implement a customer firewall or intrusion protection system.

FIG. 2 illustrates that client network 202 is coupled to a network 208. Network 208 may include one or more computing networks, such as other LANs, wide area networks (WANs), the Internet, and/or other remote networks, to transfer data between client devices 204A-E and cloud resources platform/network 210. Each of the computing networks within network 208 may contain wired and/or wireless programmable devices that operate in the electrical and/or optical domain. For example, network 208 may include wireless networks, such as cellular networks in addition to cellular network 203. Wireless networks may utilize a variety of protocols and communication techniques (e.g., Global System for Mobile Communications (GSM) based cellular network) wireless fidelity Wi-Fi networks, Bluetooth, Near Field Communication (NFC), and/or other suitable radio-based networks as would be appreciated by one of ordinary skill in the art upon viewing this disclosure. Network 208 may also employ any number of network communication protocols, such as Transmission Control Protocol (TCP) and Internet Protocol (IP). Although not explicitly shown in FIG. 2, network 208 may include a variety of network devices, such as servers, routers, network switches, and/or other network hardware devices configured to transport data over networks.

In FIG. 2, cloud resources platform/network 210 is illustrated as a remote network (e.g., a cloud network) that is able to communicate with client devices 204A-E via client network 202 and network 208. The cloud resources platform/network 210 acts as a platform that provides additional computing resources to the client devices 204A-E and/or client network 202. For example, by utilizing the cloud resources platform/network 210, users of client devices 204A-E may be able to build and execute applications, such as automated processes for various enterprise, IT, field service and/or other organization-related functions. In one embodiment, the cloud resources platform/network 210 includes one or more data centers 212, where each data center 212 could correspond to a different geographic location. Within a particular data center 212 a cloud service provider may include a plurality of server instances 214. Each server instance 214 may be implemented on a physical computing system, such as a single electronic computing device (e.g., a single physical hardware server) or could be in the form of a multi-computing device (e.g., multiple physical hardware servers). Examples of server instances 214 include, but are not limited to, a web server instance (e.g., a unitary Apache® installation), an application server instance (e.g., unitary Java Virtual Machine), and/or a database server instance (e.g., a unitary MySQL® catalog). Apache is a registered trademark of Apache Software Foundation. MySQL is a registered trademark of MySQL AB.

To utilize computing resources within cloud resources platform/network 210, network operators may choose to configure data centers 212 using a variety of computing infrastructures. In one embodiment, one or more of data centers 212 are configured using a multi-tenant cloud architecture such that a single server instance 214, which can also be referred to as an application instance, handles requests and serves more than one customer. In some cases, data centers with multi-tenant cloud architecture commingle and store data from multiple customers, where multiple client instances are assigned to a single server instance 214. In a multi-tenant cloud architecture, the single server instance 214 distinguishes between and segregates data and other information of the various customers. For example, a multi-tenant cloud architecture could assign a particular identifier for each customer in order to identify and segregate the data from each customer. In a multitenancy environment, multiple customers share the same application, running on the same operating system, on the same hardware, with the same data-storage mechanism. The distinction between the customers is achieved during application design, thus customers do not share or see each other's data. This is different than virtualization where components are transformed, enabling each customer application to appear to run on a separate virtual machine. Generally, implementing a multi-tenant cloud architecture may have a production limitation, such as the failure of a single server instance 214 causing outages for all customers allocated to the single server instance 214.

In another embodiment, one or more of the data centers 212 are configured using a multi-instance cloud architecture to provide every customer its own unique client instance. For example, a multi-instance cloud architecture could provide each client instance with its own dedicated application server and dedicated database server. In other examples, the multi-instance cloud architecture could deploy a single server instance 214 and/or other combinations of server instances 214, such as one or more dedicated web server instances, one or more dedicated application server instances, and one or more database server instances, for each client instance. In a multi-instance cloud architecture, multiple client instances could be installed on a single physical hardware server where each client instance is allocated certain portions of the physical server resources, such as computing memory, storage, and processing power. By doing so, each client instance has its own unique software stack that provides the benefit of data isolation, relatively less downtime for customers to access the cloud resources platform/network 210, and customer-driven upgrade schedules.

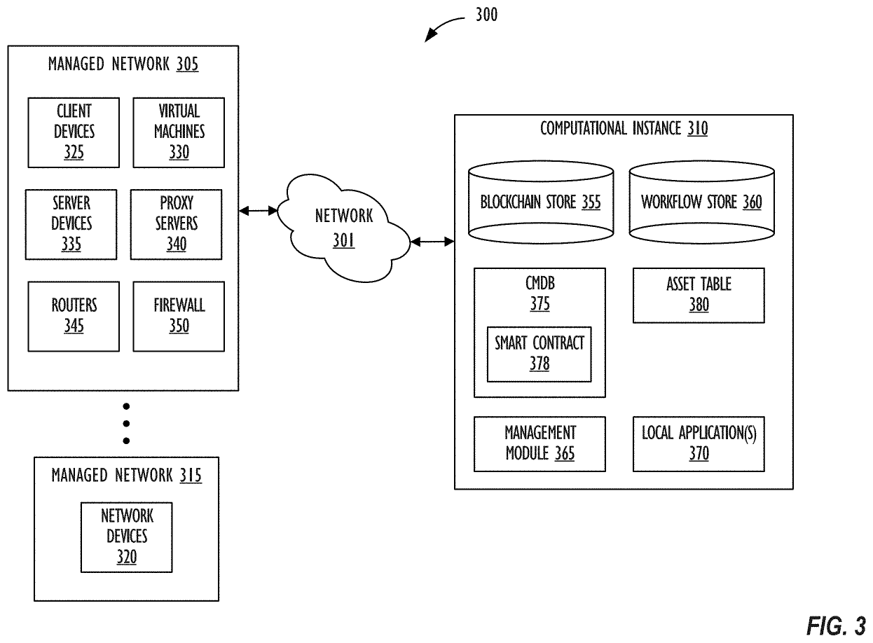

FIG. 3 illustrates a block diagram of an embodiment of a network architecture 300 where embodiments of the present disclosure may operate. This architecture includes several managed networks, including managed network 305 and managed network 315, which connects to a computational instance 310 over a network 301, such as the internet. Network 301 may be substantially similar to any of client network 102 and network 108, as described in FIG. 1, or client network 202 and network 208 of FIG. 2. Managed network 305 and managed network 315 may be, for example, an enterprise network used by an entity for computing and communications tasks, as well as storage of data. Thus, managed network 305 and managed network 315 may include various client devices 325, server devices 335, routers 345, virtual machines 330, firewall 350, and/or proxy servers 340. As shown in managed network 315, managed network 315 may collectively include network device 320.

Client devices 325 may be embodied by client device 115 or 204, server devices 335 may be embodied by computing device 110 or 206, and routers 345 may be any type of router, switch, or gateway, for example. Although the various components are described as located in particular locations and with particular functionality, in one or more embodiments, the various modules may be differently located. Further, the functionality may be differently distributed across the network infrastructure 300 or in different locations not shown.

Virtual machines 330 may be embodied by one or more of the computing devices described above. In general, a virtual machine is an emulation of a computing system, and mimics the functionality (e.g., processor, memory, and communication resources) of a physical computer. One physical computing system, such as server 335, may support up to thousands of individual virtual machines. In some embodiments, virtual machines 330 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 350 may be one or more specialized routers or server devices that protect managed network 305 from unauthorized attempts to access the devices, applications, and services therein, while allowing authorized communication that is initiated from managed network 305. Firewall 350 may also provide intrusion detection, web filtering, virus scanning, application-layer gateways, and other applications or services.

Managed network 305 may also include one or more proxy servers 340. An embodiment of proxy servers 340 may be a server device that facilitates communication and movement of data between managed network 305 and computational instance 310. In particular, proxy servers 340 may be able to establish and maintain secure communication sessions with one or more computational instances 310 of an enterprise management system. By way of such a session, a user of computational instance 310 may be able to provide enterprise services for managed network 305.

Firewalls, such as firewall 350, typically deny all communication sessions that are incoming by way of Network 301, unless such a session was ultimately initiated from behind the firewall (i.e., from a device on managed network 305) or the firewall has been explicitly configured to support the session. By placing proxy servers 340 behind firewall 350 (e.g., within managed network 305 and protected by firewall 350), proxy servers 340 may be able to initiate these communication sessions through firewall 350. Thus, firewall 350 might not have to be specifically configured to support incoming sessions from computational instance 310, thereby avoiding potential security risks to managed network 305.

In some cases, managed network 305 may consist of a few devices and a small number of networks. In other deployments, managed network 305 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 305, a varying number of proxy servers 340 may be deployed therein. For example, each one of proxy servers 340 may be responsible for communicating with computational instance 310 regarding a portion of managed network 305. Alternatively or additionally, sets of two or more proxy servers may be assigned to such a portion of managed network 305 for purposes of load balancing, redundancy, and/or high availability.

Computation instance 310 may be part of a hosted environment that provides aPaaS services to users, particularly to the operators of managed network 305. These services may take the form of web-based portals, for instance. Thus, a user can securely access computational instance 310 from, for instance, client devices 325, or potentially from a client device outside of managed network 305. By way of the web-based portals, users may design, test, and deploy applications, generate reports, view analytics, and perform other tasks.

As shown in FIG. 3, computational instance 310 may represent a set of web portals, services, and applications (e.g., a wholly-functioning aPaaS system) available to a particular customer. In some cases, a single customer may use multiple computational instances. For example, managed network 305 may be an enterprise customer of an enterprise management system, and may use computational instance 310. The reason for providing multiple instances to one customer is that the customer may wish to independently develop, test, and deploy its applications and services. A computational instance may also be referred to as a hosted instance, a remote instance, a customer instance, or by some other designation.

In order to support multiple computational instances in an efficient fashion, the enterprise management platform may implement a plurality of these instances on a single hardware platform. For example, when the aPaaS (application platform as a service) system is implemented on a server cluster such as server cluster 110, it may operate a virtual machine that dedicates varying amounts of computational, storage, and communication resources to instances. But full virtualization of server cluster 110 might not be necessary, and other mechanisms may be used to separate instances. In some examples, each instance may have a dedicated account and one or more dedicated databases on server cluster 110. Alternatively, computational instance 310 may span multiple physical devices.

Computational instance 310 may include various modules and components that may be utilized to provide optimized processes for responding to incidents, according to one or more embodiments. The computational instance 310 may include a blockchain store 355 which may store copies of blockchains associated with various assets. As will be described below, the blockchain associated with a particular asset contains a history of attributes of that asset as those attributes are modified, for example by service providers or otherwise. As an example, a blockchain may include attributes of a particular piece of inventory as it moves from one service provider to another during production. The blockchains stored in blockchain store 355 may be shared among users or devices associated with managed networks 305 and 315, for example, upon determination that the users/devices are a certified operator. In one or more embodiments, a certified operator may be determined based on an operator (e.g., a particular user or device) which has a key that provides access to a workflow for or associated with a particular asset.

The various workflows may be stored, for example, in workflow store 360. The workflow store 360 may be any kind of data structure in which the workflows may be stored. As described above, a workflow is a sequence of activities which are performed by an operator in order to perform work on or related to an asset. In one or more embodiments, the various workflows may be specific to a particular user or managed network across the enterprise. For example, different enterprise units or entities may utilize separate managed networks. As such, the different components within the managed networks may utilize workflows associated with a same asset, but may not be allowed to access the same workflows. As an example, a car body may be built according to a first workflow by a service provider utilizing a first managed network 305. Then, the built car (e.g., the asset) may be transmitted to a second service provider utilizing a second managed network (e.g., managed network 315), which may be associated with a painting service provider. The first service provider may have access to a workflow based on a first key associated with a blockchain for the asset, where the first key provides access to the workflow based on characteristics or the vehicle, or parts of the vehicle, when the workflow is invoked. The second service provider may have access to a different workflow (e.g., the painting workflow) based on a key associated with the additional aspects of the asset upon receipt of the asset (e.g., the built car). The workflows may be related to any of various types of enterprise functionality. For example, the workflows may be related to the following applications and modules utilized by the enterprise: IT Service Management, Incident Management, Problem Management, Change and Release Management, Benchmarks, Cost Management, Request Management, Configuration Management Database, Asset Management, Service Catalog, Knowledge Management, Survey and Assessment, Service Level Management, IT Operations Management, Discovery, Cloud Management, Event Management, Orchestration, Service Mapping, Operational Intelligence, IT Enterprise Management, Project Portfolio Management, Demand Management, Resource Management, Agile Development, Application Portfolio Management, Cost Transparency, Financial Planning, Financial Reporting, Performance Analytics, Software Asset Management, Security, Security Operations, Governance, Risk and Compliance, Customer Service, Customer Service Management, Field Service Management, Knowledge Management, HR Service Delivery, Case and Knowledge Management, Employee Service Center, Employee Onboarding and Transitions.

Computational instance 310 may also include a management module 365 and other local applications 370, for example which may be used by, or in conjunction with, the various workflows and/or management module 365. In one or more embodiments, the management module 365 may be utilized to manage various workflows performed by different parties to process an asset. The management module 365 may, for example, provide an interface in which a workflow is managed or performed (e.g., by a service provider). Further, in one or more embodiments, the management module 365 may be utilized to monitor performance of the workflows in workflow store 360. That is, in one or more embodiments, the management module 365 may calculate or otherwise determine a key performance indicator (“KPI”) for a workflow and manage a workflow or coordinate among entities (e.g., service providers) and workflows based on the determined KPI. As an example, if a KPI indicates that an efficiency of a workflow has fallen below a predetermined level, then a notification may be generated and transmitted, for example, to management. Returning to the car example above, the management module 365 may determine that the build is taking longer than anticipated based on the determined KPI for the build workflow, and in response, a notification may be generated and transmitted to an authority user, such as a manager of the build workflow, or another enterprise entity which oversees the build service provider and/or workflow. As an alternative example, a particular KPI may kick off an additional workflow. Returning again to the car build example, if the build is going more quickly than anticipated, the paint workflow may be kicked off such that the painting service provider to ensure that the required paint is ordered and ready for the car (e.g., the asset) when the car body is received from the builder.

In one or more embodiments, the management module 365 may also receive and/or generate and/or transmit notifications, for example, to management, in a situation in which access to a workflow has failed. For example, returning to the car example above, if the painter service provider was expecting to receive a sedan (e.g., the key held by the painter service provider to access the painting workflow is associated with a sedan body), and the painter service provider instead receives a pickup truck body, then the key held by the painter service provider will not work to provide access to the painting workflow. Rather, the management module 365 may detect the failed authorization, and generate and transmit a notification to a manager or other user.

According to one or more embodiments, the management module 365 may detect a new asset that has appeared in a managed network during execution of a workflow. As an example, the management module 365 may discover that a new truck has arrived to transmit the car. In one or more embodiments, the management module 365 may request verification that the truck should be added to a general ledger of assets. The general ledger may include the assets along with an association of the workflows and security keys associated with the assets. The verification process may include requesting confirmation of a check by a user, performing a network check, or the like. Once verified, the new asset (e.g., the tool) will be assigned a unique key to the asset, and the asset is placed in the general ledger. Returning to the truck example, the truck will be assigned a unique blockchain key, which may be added to a configuration management database (“CMDB”) 375.

The CMDB is a store which may store indications of enterprise assets. Thus, the CMDB provides an up-to-date inventory of assets (e.g., configuration items) available to an enterprise. The CMDB may additionally provide attributes for the various assets, and among the various assets. For example, the CMDB may include an indication of a relationship among assets. Indications of the assets may also be stored in an asset table, which may be linked to the CMDB 375, as well as a general ledger associated with a blockchain. The asset table may store various attributes for the asset, such as cost, type, serial number, identification number, as well as other information such as a blockchain key associated with the asset.

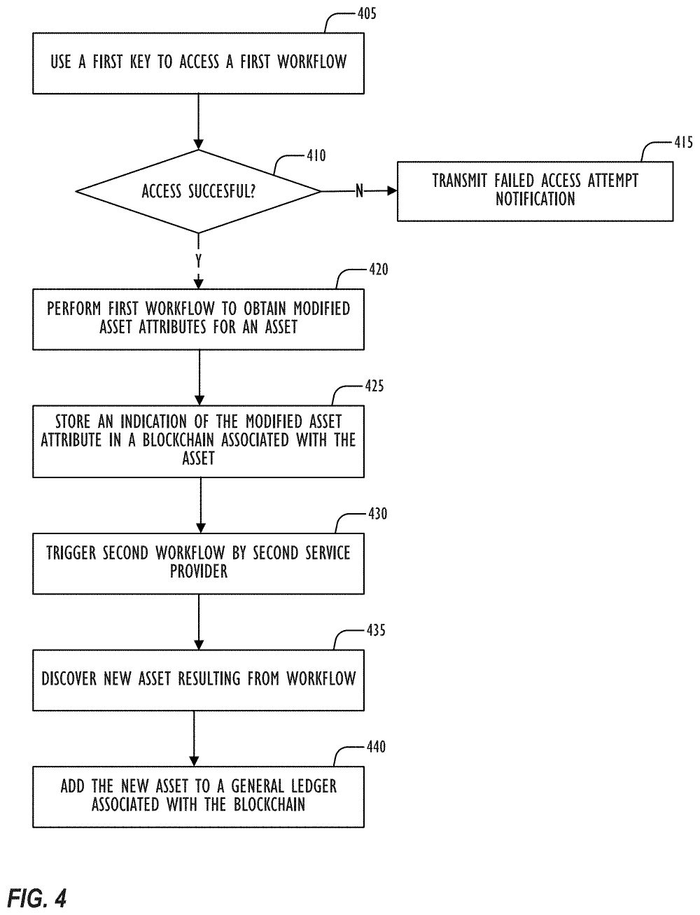

FIG. 4 illustrates a flowchart for creating and managing an immutable asset, according to one or more embodiments. Although the flowchart in FIG. 4, and each of the following flowcharts, depicts a series of steps in a particular order, it should be understood that the various steps may be performed in a different order. Further, in each of the flowcharts depicted and described below, some of the steps may not be necessary to be performed. Moreover, some of the steps may be performed in parallel, according to one or more embodiments.

The flowchart begins at 405, where a service provider users a first key to access a first workflow. As described above, the service provider may be an authorized operator who is granted access to the workflow by the key. In one or more embodiments, the system may use a blockchain authentication which authors a private key to the operator. In one or more embodiments, the operator may be provided a key based on attributes of the operator (e.g., skills, identity, or other operator attributes). Data may be available to human users at different layers based on the blockchain. In one or more embodiments, if the attributes of the operator indicate that the operator has modification rights, the operator may augment the workflow or generate a new workflow.

At 410, a determination is made regarding whether the access attempt was successful. In one or more embodiments, access may be successful if the blockchain is verified based on the key such that the attributes of the received asset matches the expected asset according to the blockchain associated with the asset. If at 410 a determination is made that the access attempt was not successful, then the flowchart continues at 415 and the management module 365 transmits a failed access attempt notification, for example, to an enterprise management system. In doing so, the integrity of the asset is preserved, thus providing an immutable asset.

Returning to 410, if a determination is made that the access attempt was successful, then the flowchart continues at 420, and the service provider performs the first workflow to obtain modified asset attributes for an asset. According to one or more embodiments, the workflow may route incidents (e.g., enterprise tasks such as in the form of tickets) to either an agent or a virtual agent. The incidents may be routed, for example, to an agent or a virtual agent. According to one or more embodiments, the agent or virtual agent may obtain data from configuration items (“CIs”) the CMDB to process the workflow.

At 425, an indication of the modified asset attribute is stored in a blockchain associated with the asset. For example, if a sedan is painted by a painting service provider, the new paint color may be added to the blockchain for the sedan. As such, a next service provider's key will be usable for a sedan received of the particular color. The flowchart continues at 430, and in one or more embodiments, a second workflow may be triggered by a second service provider.

At 435, a new asset may be discovered during the workflow (e.g., the first workflow or the second workflow). For example, a new machine utilized to perform work on the asset may be discovered. As another example, a new employee may be detected, such as a commercial driver delivering goods (e.g., the new employee may be identified as a new asset). In one or more embodiments, the discovery process may include verification of the new asset to determine whether the new asset should be added to a general ledger of assets. The verification may occur, for example, based on a human visual check, a network check, and the like.

Once approved, the flowchart concludes at 440 and the new asset is added to the general ledger associated with the blockchain. In addition, the new asset may be assigned a unique key, and an indication of the asset will be included in the asset table. As an example, a truck carrying inventory may arrive at a site to deliver goods. The truck may be discovered upon arrival. If an approved operator verifies the truck, then a new blockchain will be generated for the truck and the blockchain key may be added to the CMDB. In one or more embodiments, the discovered asset may have a CI class with attributes, such as predetermined characteristics or functionality which indicate that the asset is a “good actor” (e.g., in compliance) or, if acting or discovered to be outside the predetermined characteristics, a “bad actor” (e.g., not in compliance). Further, an indication of the truck may be stored in the asset table as associated with the blockchain and the truck asset. Then, the asset (e.g., the truck) can continue with transporting goods.

According to one or more embodiments, a proscribed path may be implemented in the form of a workflow associated with the asset. As an example, the detected truck may be associated with a delivery workflow which indicates that the truck should be transporting goods from a predetermined source to a predetermined destination. In one or more embodiments, if the management module 365 determines that the truck deviates from the proscribed path, then the truck may be determined to be a “bad actor,” and a warning notification may be generated and transmitted, for example to management.

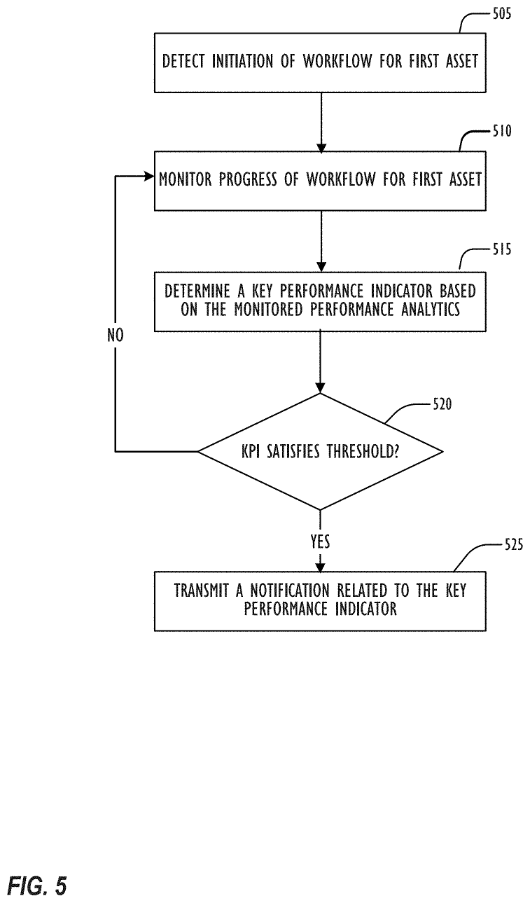

FIG. 5 shows a flowchart for managing a connected service, according to one or more embodiments. Specifically, FIG. 5 depicts a method for monitoring workflows and directing services accordingly, according to one or more embodiments. Although the flowchart in FIG. 5, and each of the following flowcharts, depicts a series of steps in a particular order, it should be understood that the various steps may be performed in a different order. Further, in each of the flowcharts depicted and described below, some of the steps may not be necessary to be performed. Moreover, some of the steps may be performed in parallel, according to one or more embodiments.

The flowchart begins at 505, and the management module 365 detects initiation of the workflow for the first asset. The flowchart continues at 510 where the management module 365 monitors progress of the workflow for the first asset, and at 515, the management module 365 determines a key performance indicator based on the monitored performance analytics. KPIs may include, for example, percentage incidents resolved, average time to solve an incident, overall number of open incidents, cost per task, time per task, and the like.

The flowchart continues at 520, where a determination is made regarding whether the KPI satisfies a threshold. If a determination is made at 520 that the KPI does not satisfy a threshold, then the flowchart returns to 510 and the management module 365 continues to monitor the process of the workflow for the first asset.

Returning to 520, if a determination is made that the KPI satisfies a threshold, then the flowchart continues at 525 and a notification related to the KPI is generated and transmitted. As will be discussed below, the notification may be related to rerouting work to alternative service providers. Further, the notification may alert a manager, either within the service provider, or in an enterprise that has tasked the service provider with processing an asset, to take remedial action.

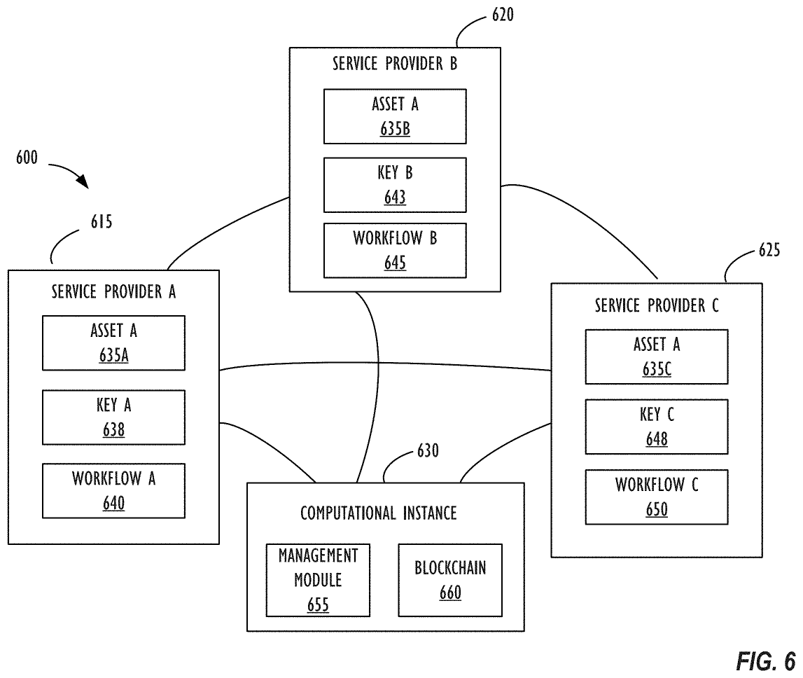

FIG. 6 shows an example flow diagram 600 illustrating connected services, according to one or more embodiments. It should be understood that the particular flow diagram illustrated and described is merely provided as an example of some embodiments of the invention. As such, the particular components of flow diagram 600 should not be considered to apply to all embodiments described herein.

The overall system may include multiple service providers, such as service provider A 615, service provider B 620, and service provider C 625, which may each provide different services with respect to an asset. As such, service provider A 615 may be responsible for processing workflow A 640, whereas service provider B 620 is responsible for workflow B 645, and service provider C 625 may be responsible for workflow C 650. A computational instance 630 may be utilized to monitor the overall procedure across several service providers. Further, one or more of the various service providers may also have access to individual computational instances, which may be specific to the various service providers. The computational instance 630 may include a management module 655 and a blockchain associated with an asset 635. The asset 635 is described using three different notations, based on the state of the asset at the service provider being described.

As an example, an overall system may be provided to construct a vehicle. The overall process to build a car may require multiple service providers. A first operator service provider, service provider A 615, may receive car parts and assemble a car body with the parts. The assembly may be defined by a workflow A 640. In one or more embodiments, the first service provider A 615 may kick off the construction utilizing the received parts. For example, service provider A 615 may utilize a key A 638 that provides access to the workflow A 635 based on current attributes of asset A 635A as stored in blockchain 660 in order to service provider A 615 to do work on the asset. In one or more embodiments, management module 655 may begin monitory data analytics to determine how the process is functioning, for example if the build is occurring according to a predetermined series of steps, at an expected level of efficiency, and the like. As the build is completed, or upon completion, the new attributes of the Asset A 635A are stored in blockchain 660, which is associated with asset A 635 as it is processed.

The overall production or processing of a particular asset A 635 may be managed overall by one or more managers using computational instance 630. Based on the analytics (e.g., determined KPIs), if the build is proceeding as expected, then the management module 655 may notify service provider B 620 (e.g., a painting service provider), to kick off the next workflow B 645. Alternatively, each of service provider A 615 and service provider B 620 may have access to blockchain 620 associated with asset A 635 such that when the blockchain 620 indicates that the attributes of asset A 635A have reached a particular level of completion, then key B 643 will provide access to workflow B 645 to initiate the painting workflow. In one or more embodiments, if a workflow is kicked off, a kick off notification may be generated and transmitted, for example to management. Thus, service provider B 620 may receive a car body from service provider A 615, and paint the car body (e.g., asset A 635B) according to workflow B 645. Similarly, a painted car body (e.g., asset A 635C) may be prepared for delivery by service provider C 625 based on workflow C 650 accessible by key C 648.

In one or more embodiments the three service providers (e.g., service provider A 615, service provider B 620, and service provider C 625) may be connected in a connected service configuration. As such, management module 655 may provide additional services to an enterprise that utilizes the services of the various service providers. For example, the management module 655 may track a particular output variables, such as risk, revenue, customer experience, and efficiency. The management module 655 may utilize an algorithm to attain a particular benchmark. As such, the management module may track various characteristics of the service providers, such as proximity (e.g., by using GPS data), availability, service functionality (e.g., rated levels or performance), and the like. For example, the management module 655 may determine when a substitute service provider should be introduced to reach the benchmark. As such, the management module may redistribute keys that provide access to the workflows for the asset. As an example, if service provider A 615 is to be replaced, key A 638 may be invalidated, and a new service provider may be provided with a key that provides access to workflow A 640.

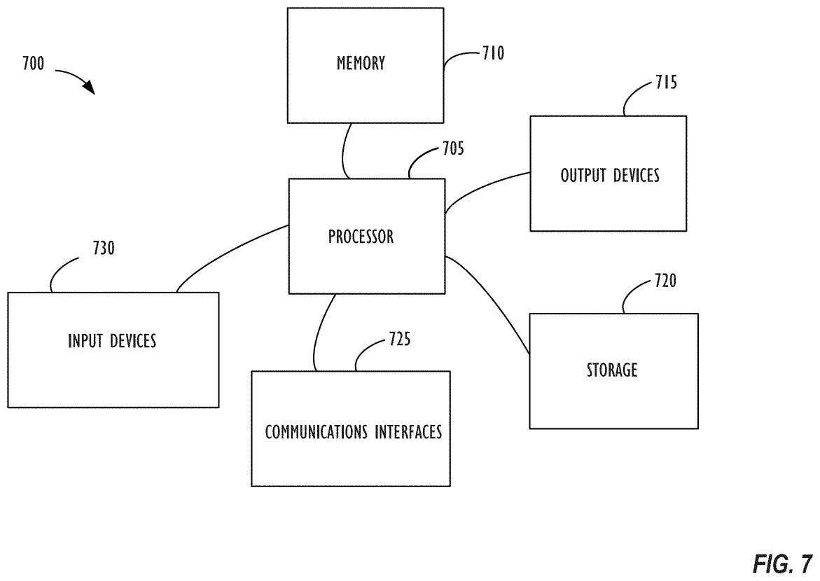

FIG. 7 illustrates a high-level block diagram 700 of a processing device (computing system) that may be used to implement one or more disclosed embodiments (e.g., data server computers 110, client computers 115, cloud resources platform/network 210, client devices 204A-204E, computational instance 310, server instances 214, managed network 305, etc.). For example, computing device 700 illustrated in FIG. 7 could represent a client device or a physical server device and include either hardware or virtual processor(s) depending on the level of abstraction of the computing device. In some examples (without abstraction) computing device 700 and its elements as shown in FIG. 7 each relate to physical hardware and in some examples one, more, or all of the elements could be implemented using emulators or virtual machines as levels of abstraction. In any case, no matter how many levels of abstraction away from the physical hardware, computing device 700 at its lowest level may be implemented on physical hardware. As also shown in FIG. 7, computing device 700 may include one or more input devices 730, such as a keyboard, mouse, touchpad, or sensor readout (e.g., biometric scanner) and one or more output devices 715, such as displays, speakers for audio, or printers. Some devices may be configured as input/output devices also (e.g., a network interface or touchscreen display). Computing device 700 may also include communications interfaces 725, such as a network communication unit that could include a wired communication component and/or a wireless communications component, which may be communicatively coupled to processor 705. The network communication unit may utilize any of a variety of proprietary or standardized network protocols, such as Ethernet, TCP/IP, to name a few of many protocols, to effect communications between devices. Network communication units may also comprise one or more transceivers that utilize the Ethernet, power line communication (PLC), Wi-Fi, cellular, and/or other communication methods.

As illustrated in FIG. 7, processing device 700 includes a processing element such as processor 705 that contains one or more hardware processors, where each hardware processor may have a single or multiple processor cores. In one embodiment, the processor 705 may include at least one shared cache that stores data (e.g., computing instructions) that are utilized by one or more other components of processor 705. For example, the shared cache may be a locally cached data stored in a memory for faster access by components of the processing elements that make up processor 705. In one or more embodiments, the shared cache may include one or more mid-level caches, such as level 2 (L2), level 3 (L3), level 4 (L4), or other levels of cache, a last level cache (LLC), or combinations thereof. Examples of processors include, but are not limited to a central processing unit (CPU) or a microprocessor. Although not illustrated in FIG. 7, the processing elements that make up processor 705 may also include one or more other types of hardware processing components, such as graphics processing units (GPUs), application specific integrated circuits (ASICs), field-programmable gate arrays (FPGAs), and/or digital signal processors (DSPs).

FIG. 7 illustrates that memory 710 may be operatively and communicatively coupled to processor 705. Memory 710 may be a non-transitory medium configured to store various types of data. For example, memory 710 may include one or more volatile devices such as random access memory (RAM). Non-volatile storage devices 720 can include one or more disk drives, optical drives, solid-state drives (SSDs), tap drives, flash memory, read only memory (ROM), and/or any other type memory designed to maintain data for a duration time after a power loss or shut down operation. In certain embodiments, the non-volatile storage devices 720 may be used to store overflow data if allocated RAM is not large enough to hold all working data. The non-volatile storage devices 720 may also be used to store programs that are loaded into the RAM when such programs are selected for execution.

Persons of ordinary skill in the art are aware that software programs may be developed, encoded, and compiled in a variety of computing languages for a variety of software platforms and/or operating systems and subsequently loaded and executed by processor 705. In one embodiment, the compiling process of the software program may transform program code written in a programming language to another computer language such that the processor 705 is able to execute the programming code. For example, the compiling process of the software program may generate an executable program that provides encoded instructions (e.g., machine code instructions) for processor 705 to accomplish specific, non-generic, particular computing functions.

After the compiling process, the encoded instructions may then be loaded as computer executable instructions or process steps to processor 705 from storage 720, from memory 710, and/or embedded within processor 705 (e.g., via a cache or on-board ROM). Processor 705 may be configured to execute the stored instructions or process steps in order to perform instructions or process steps to transform the computing device into a non-generic, particular, specially programmed machine or apparatus. Stored data, e.g., data stored by a storage device 720, may be accessed by processor 705 during the execution of computer executable instructions or process steps to instruct one or more components within the computing device 700.

A user interface (e.g., output devices 715 and input devices 730) can include a display, positional input device (such as a mouse, touchpad, touchscreen, or the like), keyboard, or other forms of user input and output devices. The user interface components may be communicatively coupled to processor 705. When the output device is or includes a display, the display can be implemented in various ways, including by a liquid crystal display (LCD) or a cathode-ray tube (CRT) or light emitting diode (LED) display, such as an organic LED (OLED) display. Persons of ordinary skill in the art are aware that the computing device 700 may comprise other components well known in the art, such as sensors, powers sources, and/or analog-to-digital converters, not explicitly shown in FIG. 7.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes 2, 3, 4, etc.; greater than 0.10 includes 0.11, 0.12, 0.13, etc.). The use of the term “about” means ±10% of the subsequent number, unless otherwise stated.

Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure.

It is to be understood that the above description is intended to be illustrative and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. It should be noted that the discussion of any reference is not an admission that it is prior art to the present invention, especially any reference that may have a publication date after the priority date of this application.

What is claimed is:

1. A non-transitory computer readable storage medium comprising computer readable code executable by one or more processors to:
utilize, by a first service provider, a first key associated with a first asset to access a first workflow associated with the first asset, wherein the workflow is enabled in response to verifying the first asset using the first key;
perform the first workflow to obtain modified asset attributes for the first asset; and
store an indication of the modified asset attributes in a blockchain associated with the first asset,
wherein the second service provider has a second key associated with the modified first asset and access to the blockchain.

2. The non-transitory computer readable medium of claim 1, wherein the first service provider is associated with the first workflow and the first security key in a general ledger associated with the blockchain.

3. The non-transitory computer readable medium of claim 1, further comprising computer readable code to:
attempt to access, by a first service provider, a second workflow associated with a second asset using a second key, wherein the second workflow is enabled in response to verifying the first asset using the first key;
in response to determining that access to the second workflow has failed, transmit a notification of the failed access attempt.

4. The non-transitory computer readable medium of claim 1, further comprising computer readable code to:
monitor performance analytics for the first workflow;
determine a key performance indicator based on the monitored performance analytics; and
in response to determining that the key performance indicator satisfies a threshold value, transmit a notification related to the key performance indicator.

5. The non-transitory computer readable storage medium of claim 4, wherein the notification is transmitted to an enterprise management system.

6. The non-transitory computer readable storage medium of claim 5, wherein the first service provider accesses the first workflow from an enterprise device managed by the enterprise management system.

7. The non-transitory computer readable storage medium of claim 4, further comprising computer readable code to:
in response to determining that key performance index satisfies a completion threshold value, activating an additional workflow for the first asset.

8. The non-transitory computer readable medium of claim 1, wherein an indication of the first asset is stored in an asset table linked to a configuration management database.

9. The non-transitory computer readable medium of claim 1, further comprising computer readable code to:
discover, in response to performance of the first workflow, a new asset; and
add the new asset to a general ledger associated with the blockchain.

10. A system comprising:
one or more processors; and
one or more computer readable storage medium comprising computer readable code executable by the one or more processors to:
utilize, by a first service provider, a first key associated with a first asset to access a first workflow associated with the first asset, wherein the workflow is enabled in response to verifying the first asset using the first key;
perform the first workflow to obtain modified asset attributes for the first asset; and
store an indication of the modified asset attributes in a blockchain associated with the first asset,
wherein the second service provider has a second key associated with the modified first asset and access to the blockchain.

11. The system of claim 10, wherein the first service provider is associated with the first workflow and the first security key in a general ledger associated with the blockchain.

12. The system of claim 10, further comprising computer readable code to:
attempt to access, by a first service provider, a second workflow associated with a second asset using a second key, wherein the second workflow is enabled in response to verifying the first asset using the first key;
in response to determining that access to the second workflow has failed, transmit a notification of the failed access attempt.

13. The system of claim 10, wherein an indication of the first asset is stored in an asset table linked to a configuration management database.

14. A method comprising:
utilizing, by a first service provider, a first key associated with a first asset to access a first workflow associated with the first asset, wherein the workflow is enabled in response to verifying the first asset using the first key;
performing the first workflow to obtain modified asset attributes for the first asset; and
storing an indication of the modified asset attributes in a blockchain associated with the first asset,
wherein the second service provider has a second key associated with the modified first asset and access to the blockchain.

15. The method of claim 14, further comprising:
monitoring performance analytics for the first workflow;
determining a key performance indicator based on the monitored performance analytics; and
in response to determining that the key performance indicator satisfies a threshold value, transmitting a notification related to the key performance indicator.

16. The method of claim 15, wherein the notification is transmitted to an enterprise management system.

17. The method of claim 16, wherein the first service provider accesses the first workflow from an enterprise device managed by the enterprise management system.

18. The method of claim 15, further comprising:
in response to determining that key performance index satisfies a completion threshold value, activating an additional workflow for the first asset.

19. The method of claim 14, wherein an indication of the first asset is stored in an asset table linked to a configuration management database.

20. The method of claim 14, further comprising:
discovering, in response to performance of the first workflow, a new asset; and
adding the new asset to a general ledger associated with the blockchain.
